(19) United States
(12) Patent Application Publication
(10) Pub. No.: US 2019/0216259 A1
(43) Pub. Date: Jul. 18, 2019

(54) COLLAPSABLE BABY BOTTLE WARMER

(71) Applicant: Cindy Belance, Randolph, MA (US)

(72) Inventor: Cindy Belance, Randolph, MA (US)

(21) Appl. No.: 15/858,495

(22) Filed: Dec. 29, 2017

(51) Int. Cl. A47J 36/24; H05B 1/02; H05B 3/58

(52) U.S. Cl. CPC A47J 36/2433; H05B 3/58; H05B 1/0269

(57) ABSTRACT

Apparatus which includes an accordion sleeve having an axis and has a 1^{st} position in which the sleeve is axially extended and a 2^{nd} position in which the sleeve is axially contracted. The sleeve is dimensioned for receiving a generally cylindrical food product container when the sleeve is axially extended. A housing supports apparatus for generating heat in the accordion sleeve, the housing including 1^{st} and 2^{nd} meshing parts having a 1^{st} position in which the 1^{st} and 2^{nd} meshing parts engage to hold the accordion sleeve in the 2^{nd} position of the accordion sleeve in which the sleeve is axially contracted.

### TECHNICAL FIELD

The present invention is generally directed to feeding apparatus. More particularly, the present invention is directed to infant feeding apparatus. Even more particularly, the present invention is directed to baby bottle warming apparatus.

### BACKGROUND OF THE INVENTION

Although the present invention is referred to a baby bottle warming apparatus it will be understood that the present invention also has application to heating breast milk, formula and baby food jars. A difficulty encountered in the commonly available devices of this nature is that they are rather bulky an inconvenient to utilize when traveling. The heating apparatus is of course one item of many items that infant caretakers must carry when traveling. The many items include, but are not limited to extra closing, diapers, and various food products. Collectively, these items are difficult for the infant caretaker to carry and utilize.

From the above, it is therefore seen that there exists a need in the art to overcome the deficiencies and limitations described herein and above. More particularly, there is a need to provide warming apparatus which is more compact.

### SUMMARY OF THE INVENTION

The shortcomings of the prior art are remediated, and additional advantages are provided in apparatus which includes an accordion sleeve having an axis, the sleeve having a 1st position in which the sleeve is axially extended and a 2nd position in which the sleeve is axially contracted, the sleeve being dimensioned and configured for receiving an associated generally cylindrical food product container when the sleeve is axially extended. The apparatus also includes apparatus for generating heat disposed within the sleeve that is disposed for heat transfer relationship when the associated generally cylindrical food product. A housing supports the apparatus for generating heat and the accordion sleeve, the housing including 1st and 2nd meshing parts having a 1st position in which the 1st and 2nd meshing parts engage to hold the accordion sleeve in the 2nd position of the accordion sleeve in which the sleeve is axially contracted, the 1st and 2nd meshing parts having a 2nd position in which the 1st and 2nd meshing parts are not engaged to allow movement of the accordion sleeve to the 1st position in which the sleeve is axially extended.

In some forms of the invention the accordion sleeve is dimensioned and configured whereby the accordion sleeve is extended when no external forces are applied thereto. The accordion sleeve may be manufactured of silicone and the apparatus for generating heat may be an electric resistance heater.

Accordingly, it is an object of the present invention to provide warming apparatus that is readily expandable for immediate use and readily contracts for storage or movement incident to the travel plans of the infant care taker.

It is yet another object of the present invention to provide apparatus that is easy to use as well as inexpensive to manufacture.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description considered with the accompanying drawings in which:

FIG. 1 is a partially broken away side view of one embodiment of a collapsed baby bottle warmer in accordance with one form of the present invention,

FIG. 2 is a side view of the apparatus shown in FIG. 1 in the expanded position and the top thereof in exploded relation,

FIG. 3 is an isometric view of the apparatus shown in FIG. 2,

FIG. 4 is an exploded view of the respective parts of the apparatus shown in FIGS. 1-3, and

FIG. 5 is an exploded view showing in greater detail the accordion sleeve and the attachments thereto shown as an assembly in FIG. 4.

### DETAILED DESCRIPTION

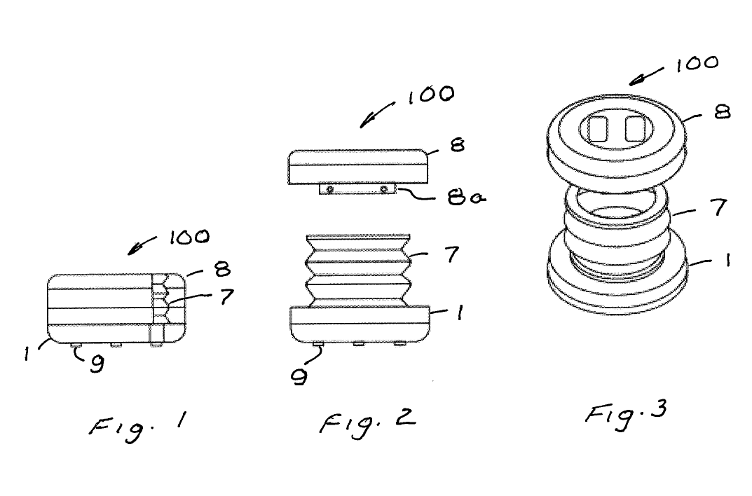

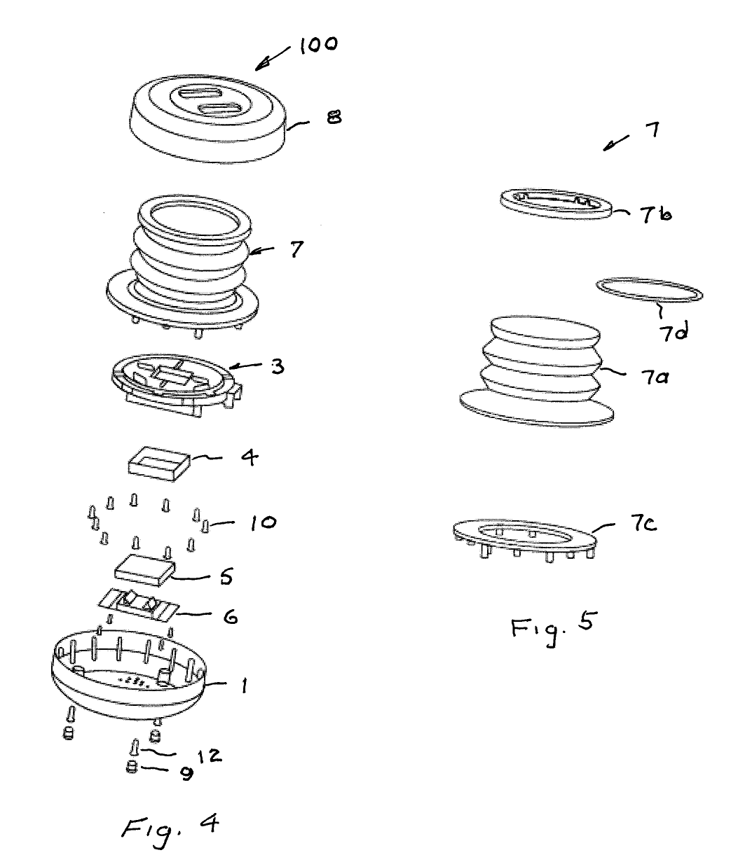

Referring now to FIGS. 1-5 showing one embodiment of the baby bottle warming apparatus 100. The apparatus includes a bottom shell 1 which holds a power adapter 2. The power adapter 2 is connected by a cable (not shown to simplify the drawing) the connection to line voltage. Line voltage in the United States typically 110 VAC. The power adapter 2, in most embodiments of the present invention converts 110 VAC to a lower DC voltage. That lower DC voltage to cooperates with a heating aluminum plate 5 that includes an integral resistance heating coil (not separately shown). To simplify the drawing the wiring between the power adapter 2 and the heating aluminum plate 5 is not shown. Any adapter plate 6 engages the bottom shell 1 and secured thereto by screws 12. The adapter plate 6 is provided with latching surfaces that engage opposed sides of the heating aluminum plate 5. A silicon gasket 4 surrounds the heating aluminum plate 5 to prevent passage of any liquid spills.

A base 3 that is dimensioned and configured for engagement with the bottom shell 1 supports the accordion sleeve assembly 7. The accordion sleeve assembly 7 is shown in greater detail in the exploded view illustrated in FIG. 5. A top locking cover 8 engages the base 3 when the accordion sleeve assembly 7 is collapsed. Disengagement of locking cover 8 from the base 3 allows axial expansion of the accordion sleeve 7. The sleeve 7a of the accordion sleeve assembly shown in FIG. 4 will be understood to be manufactured, in a preferred embodiment, of silicone. More particularly, it will be understood that the sleeve 7 will been manufactured in a manner that results in a sleeve that is expanded in the absence of external forces. Thus, when the user desires to collapse the apparatus push the locking cover 8 toward the bottom shell 1 and engage those parts in the manner illustrated in FIG. 1. Conversely when the user wishes to heat, for example, a baby bottle, on the user will disengage the locking cover 8 from the base 3. Thereafter, the sleeve 7 will naturally expand to allow placement of a baby bottle within the sleeve 7 followed by heating to the desired temperature.

The accordion sleeve assembly 7 is shown in greater detail in FIG. 5. More particularly it includes a silicone sleeve 7a in addition to an upper cover lock 7b, a lock ring 7d and a lower cover lock 7c for attachment of the accordion sleeve assembly 7 to the cooperating structure.

It will be understood that the locking cover 8 includes a retention sleeve 8a that engages the base 3 on of when the apparatus 100 is in the collapsed position as shown in FIG. 1.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address every single problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. Apparatus which comprises:
an accordion sleeve having an axis, said sleeve having a 1^{st} position in which said sleeve is axially extended and a 2^{nd} position in which said sleeve is axially contracted, said sleeve being dimensioned and configured for receiving an associated generally cylindrical food product container when said sleeve is axially extended;
apparatus for generating heat disposed within said sleeve disposed for heat transfer relationship when the associated generally cylindrical food product;
a housing supporting said apparatus for generating heat and said accordion sleeve, said housing including 1^{st} and 2^{nd} meshing parts having a 1^{st} position in which said 1^{st} and 2^{nd} meshing parts engage to hold said accordion sleeve in said 2^{nd} position of said accordion sleeve in which said sleeve is axially contracted, said 1^{st} and 2^{nd} meshing parts having a 2^{nd} position in which said 1^{st} and 2^{nd} meshing parts are not engaged to allow movement of said accordion sleeve to said 1^{st} position in which said sleeve is axially extended.

2. The apparatus as described in claim 1 wherein said accordion sleeve is dimensioned and configured whereby said accordion sleeve is extended when no external forces are applied thereto.

3. The apparatus as described in claim 1 wherein said accordion sleeve is manufactured of silicone.

4. The apparatus as described in claim 2 wherein said accordion sleeve is manufactured of silicone.

5. The apparatus as described in claim 1 wherein said apparatus for generating heat is an electric resistance heater.
